(19) United States
(12) Patent Application Publication
(10) Pub. No.: US 2025/0201861 A1
(43) Pub. Date: Jun. 19, 2025

(54) CERAMIC COMPOSITE DIELECTRIC COATING

(71) Applicant: FORD GLOBAL TECHNOLOGIES, LLC, Dearborn, MI (US)

(72) Inventors: Insik JEON, Novi, MI (US); Jonghwan PARK, Ann Arbor, MI (US); DongHyun LEE, Northville, MI (US); Gary Thomas MARTINI, Dexter, MI (US)

(21) Appl. No.: 18/539,196

(22) Filed: Dec. 13, 2023

(51) Int. Cl. H01M 4/62; H01M 4/02; H01M 4/04; H01M 4/139; H01M 50/46

(52) U.S. Cl. CPC H01M 4/628; H01M 4/0404; H01M 4/0471; H01M 4/139; H01M 4/623; H01M 50/46; H01M 2004/021; H01M 2004/028

(57) ABSTRACT

A battery with a positive electrode assembly has a metal foil current collector with a positive active material coated on one portion. Adjacent to the positive active material coated portion, the metal foil current collector is coated with a ceramic composite dielectric material from the positive active material coated portion to an uncoated portion. The ceramic composite dielectric material comprises a polyimide binder and ceramic filler. This coating extends from the area of the positive active material towards the uncoated end of the metal foil current collector.

### TECHNICAL FIELD

This disclosure relates to electrode coatings used in batteries.

### BACKGROUND

A variety of materials may be used in the manufacture of battery electrodes. Some materials are used as substrates. Other materials are used as coatings.

### SUMMARY

A battery with a negative electrode assembly and a positive electrode assembly is provided. The positive electrode assembly comprises a metal foil current collector with a positive active material coated on a part of it. Additionally, a ceramic composite dielectric material, made of a polyimide binder and ceramic filler, is coated on another portion of the metal foil current collector. This coating extends adjacent to and away from the positive active material towards an uncoated end of the metal foil current collector. A separator is disposed between the negative and positive electrode assemblies, such that the ceramic composite dielectric material reaches at least to the end of the separator. The movement of the uncoated end towards the separator, results in contact between the ceramic composite dielectric material and the end of the separator.

The ceramic filler in the battery may be a carbon oxide, such as Al2O₃ (Aluminum Oxide), ZrO₂ (Zirconium Dioxide), as well as other materials like Al2O₃(Aluminum Oxide), ZrO₂ (Zirconium Dioxide), AlOOH (Aluminum Oxide Hydroxide), Al(OH)₃ (Aluminum Hydroxide), Pb(Zr,Ti)O₃ (Lead Zirconate Titanate, PZT), TiO₂ (Titanium Dioxide), Y₂O₃(Yttrium Oxide), YSZ (Yttria-Stabilized Zirconia), Dy₂O₃ (Dysprosium Oxide), Gd2O3 (Gadolinium Oxide), CeO₂ (Cerium Oxide), GDC (Gadolinia-Doped Ceria), MgO (Magnesium Oxide), BaTiO₃ (Barium Titanate), NiMn₂O₄ (Nickel Manganese Oxide), KNaNbO₃ (Potassium Sodium Niobate), BiKTiO₃ (Bismuth Potassium Titanate), BiFeO₃ (Bismuth Ferrite), Bi_{1.5}ZnNb_{1.5}O₇ (Bismuth Zinc Niobate), WO (Tungsten Oxide, typically WO₃ or WO₂), SnO₂ (Tin Oxide), LSMO (Lanthanum Strontium Manganese Oxide), LSFC (Lanthanum Strontium Ferrite Cobaltite), AlN (Aluminum Nitride), SiN (Silicon Nitride, typically Si₃N₄), SiO₂ (Silicon Dioxide), ZnO (Zinc Oxide), HfO2 (Hafnium Oxide), TiN (Titanium Nitride), SiC (Silicon Carbide), TiC (Titanium Carbide), WC (Tungsten Carbide), MgB (Magnesium Boride, typically MgB₂), TiB (Titanium Boride), CaO (Calcium Oxide), CoFe₂O₄(Cobalt Ferrite), NiFe₂O₄(Nickel Ferrite), BaFe2O₄ (Barium Ferrite), NiZnFe₂O₄ (Nickel Zinc Ferrite), ZnFe₂O₄ (Zinc Ferrite), or MnxCo₃₋ₓO₄ (Manganese Cobalt Oxide). Alternatively, the ceramic filler may be a nitride, such as Aluminum Nitride (AlN), Silicon Nitride (Si₃N₄), or Titanium Nitride (TiN). In other configurations, the ceramic filler 28 may be a carbide, such as Silicon Carbide (SiC), Titanium Carbide (TiC), or Tungsten Carbide (WC).

The ratio of polyimide binder to ceramic filler may be between 10:90 and 30:70. The polymeric binder may be PI, PAI, PVDF, PU, and others. The particle size of the ceramic may be less than 10 microns, preferably between 0.1 and 2.0 microns. The thickness of the ceramic composite dielectric material may be between 1 to 100 microns, and more specifically, should be between 1 and 50 microns, measured from the surface of the metal foil current collector to the surface of the ceramic composite dielectric material. In some configurations, the ceramic composite dielectric material extends past the end of the separator.

A manufacturing method for positive electrode assemblies of a battery is described. Each assembly includes a metal foil current collector, a positive active material on part of the current collector, and a ceramic composite dielectric material. This material comprises polyimide binder and ceramic filler, coated on a different portion of the metal foil, extending from the positive active material to an uncoated end. During manufacturing, an automatic chromatic analysis is used to inspect the ceramic composite dielectric material. If this analysis reveals a lack of yellow or brown color in a region of the material, the affected electrode assembly is segregated from the batch. The ceramic filler in the dielectric material may be chosen from a group that includes oxides, nitrides, carbides, or borides. An optional additional step of the method involves assembling the positive electrode assemblies with separators and negative electrodes to form complete battery cells.

Another method for manufacturing positive electrode assembly for a battery, involves applying a ceramic composite dielectric slurry of polyamic acid and ceramic filler, onto a metal foil that serves as the current collector. This slurry is applied from a section of the metal foil that is already coated with an active material, extending to an uncoated end of the foil. After the application, the slurry is cured into a ceramic composite dielectric material. This material comprises a polyimide binder and the ceramic filler. This forms a positive electrode assembly that integrates the ceramic composite dielectric with the metal foil current collector.

A battery with a negative electrode assembly and a positive electrode assembly. The positive electrode assembly comprises a metal foil current collector with a positive active material coated on a part of it. Additionally, a ceramic composite dielectric material, made of a polyimide binder and ceramic filler, is coated on another portion of the metal foil current collector. This coating extends adjacent to and away from the positive active material towards an uncoated end of the metal foil current collector. A separator is placed between the negative and positive electrode assemblies, such that the ceramic composite dielectric material reaches past the end of the separator. The movement of the uncoated end towards the separator, results in contact between the ceramic composite dielectric material and the end of the separator.

### BRIEF DESCRIPTION OF THE DRAWINGS

FIG. 1 is a schematic illustration of a battery according to one embodiment;

FIG. 1′ is a schematic illustration of a battery according to one embodiment;

FIG. 2 is a schematic illustration of a ceramic composite dielectric material according to one embodiment;

FIG. 3 is a diagram of a polyamic acid undergoing a curing process to form polyimides according to one embodiment; and

FIG. 4 is a flowchart of a method according to one embodiment.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electrical contact between the cathode tab and the anode layer may occur in some batteries. In some designs, the cathode tab, which connects the cathode to the external circuit, may be positioned close to the anode layer. This proximity raises the likelihood of electrical contact. Such may occur across different styles of batteries, including cylindrical, prismatic, and pouch cells. Each type has distinct structural aspects that may contribute to the potential for contact. For example, the winding process in cylindrical cells may lead to the displacement or deformation of the cathode tab, increasing the likelihood of contact with the anode. Similarly, in prismatic and pouch cells, the method of stacking the layers and the pressure applied to maintain cell integrity may create conditions conducive to contact.

An aspect of this disclosure involves the application of dielectric coatings to prevent the contact mentioned above. In this context, polyamic acid is utilized as a binder and precursor to polyimide in the coating slurry. This substance, upon undergoing thermal curing, transforms into polyimide, forming a stable dielectric coating layer. This process helps in creating a barrier against electrical contact between the cathode tab and the anode layer.

Polyamic acids used in this process may take various forms, including carboxylic acids, neutralized carboxylates, or a blend of these. The presence of neutralized carboxylates, which may include cations like Li⁺, Na⁺, K⁺, NH₄⁺, Cs⁺, etc., affect the curing process. The cations in neutralized carboxylates may act as catalysts. The cations facilitate the rearrangement and polymerization reactions that convert polyamic acids into polyimides. By lowering the activation energy required for the curing reaction, these cations also reduce the need for high temperatures in the manufacturing process. Polyimides have an intrinsic yellow to brownish coloration. This characteristic is beneficial in the context of manufacturing as it allows for the easier detection of coating defects through conventional vision systems. The polyimide used may be unsubstituted polyimide, bisphenyl-substituted polyimide, polyimide with ethylenic linkage, trifluoromethyl-substituted polyimide, keto-substituted polyimide or other suitable polyimides. Specific examples of polyimides may be PI (polyimide), PAI (poly amide imide), PVDF (polyvinylidene fluoride), PU (polyurethane), polyurea, PC (polycarbonate), PET (polyethylene terephthalate), PMMA (polymethyl methacrylate), PBT (polybutylene terephthalate), PVA (polyvinyl alcohol), or PVB (polyvinyl butyral).

The composition of the dielectric coating detailed may be formulated with the ratio of polyimide binder to ceramic filler adjustable within a range from 1:99 to 99:1. A preferred ratio may be between 10:90 and 30:70. The ceramic filler may be Al2O₃ (Aluminum Oxide), ZrO₂ (Zirconium Dioxide), as well as other materials like Al2O3 (Aluminum Oxide), ZrO₂ (Zirconium Dioxide), AlOOH (Aluminium Oxide Hydroxide), Al(OH)₃ (Aluminium Hydroxide), Pb(Zr,Ti)O₃ (Lead Zirconate Titanate, PZT), TiO₂ (Titanium Dioxide), Y₂O₃(Yttrium Oxide), YSZ (Yttria-Stabilized Zirconia), Dy₂O₃ (Dysprosium Oxide), Gd2O3 (Gadolinium Oxide), CeO₂ (Cerium Oxide), GDC (Gadolinia-Doped Ceria), MgO (Magnesium Oxide), BaTiO₃ (Barium Titanate), NiMn₂O₄ (Nickel Manganese Oxide), KNaNbO₃ (Potassium Sodium Niobate), BiKTiO₃ (Bismuth Potassium Titanate), BiFeO₃ (Bismuth Ferrite), Bi_{1.5}ZnNb_{1.5}O₇ (Bismuth Zinc Niobate), WO (Tungsten Oxide, typically WO₃ or WO₂), SnO₂ (Tin Oxide), LSMO (Lanthanum Strontium Manganese Oxide), LSFC (Lanthanum Strontium Ferrite Cobaltite), AlN (Aluminum Nitride), SiN (Silicon Nitride, typically Si₃N₄), SiO₂ (Silicon Dioxide), ZnO (Zinc Oxide), HfO2 (Hafnium Oxide), TiN (Titanium Nitride), SiC (Silicon Carbide), TiC (Titanium Carbide), WC (Tungsten Carbide), MgB (Magnesium Boride, typically MgB₂), TiB (Titanium Boride), CaO (Calcium Oxide), CoFe₂O₄ (Cobalt Ferrite), NiFe₂O₄ (Nickel Ferrite), BaFe2O₄ (Barium Ferrite), NiZnFe₂O₄ (Nickel Zinc Ferrite), ZnFe₂O₄ (Zinc Ferrite), or MnxCo₃₋ₓO₄ (Manganese Cobalt Oxide). or other various suitable oxides, nitrides, or carbides. The particle size of the ceramic filler material may be up to 10 microns, but preferably less than 2 microns.

The thickness of the coating layer may range from 1 to 100 micrometers on each side, though preferably may be between 1 to 50 micrometers. This coating is applied to the cathode current collector, such as an aluminum foil, and extends slightly over the edge of the cathode coatings. This configuration may reduce deformation of the current collector foil and keep an equal thickness of the top and bottom dielectric coatings.

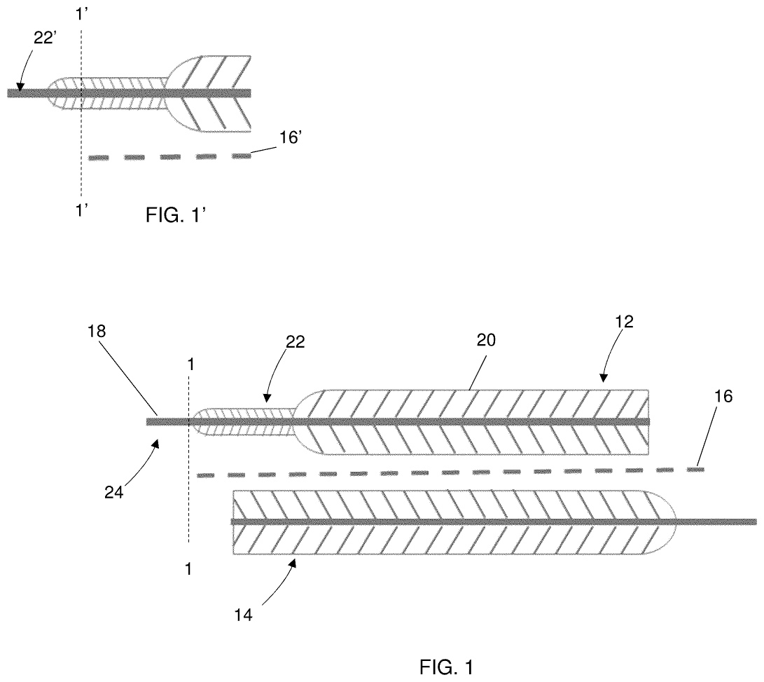

Referring to the drawings, FIG. 1 illustrates a schematic view of a battery 10 according to one aspect of the disclosure. The battery 10 can be any lithium-ion battery such as a prismatic, pouch or cylindrical cell battery. The battery 10 has a positive electrode 12, a negative electrode 14, and a separator 16. The positive electrode 12 comprises a current collector 18, which can be any suitable metal foil current collector such as an aluminum metal foil. Positive active material 20 is coated on to a portion of the current collector 18. A ceramic composite dielectric material 22 is coated on to a portion of the current collector 18 adjacent to and extending away from the positive active material 20 toward an uncoated end 24 of the current collector 18. The ceramic composite dielectric material 22 extends at least to the separator 16 as shown by the 1-1 line. However, in some configurations as shown in FIG. 1′, the ceramic composite dielectric material 22′ extends past the separator 16′ as shown by the 1′-1′ line.

A thickness of the ceramic composite dielectric material 22 ranges from 1 to 100 microns, preferably the thickness is between 1 and 50 microns, measured from the surface of the current collector 16 to the surface of the ceramic composite dielectric material 22. The arrangement of the separator 16 between the negative electrode assembly 14 and the positive electrode assembly 12, along with the ceramic composite dielectric material 22, is intended to reduce contact modes which may occur such as separator edge folding or curling. If there is movement of the uncoated portion 24 of the positive electrode 12 toward the separator 16, it results in contact between the ceramic composite dielectric material 22 and the separator 16 or negative electrode 14, rather than direct contact with the uncoated end 24.

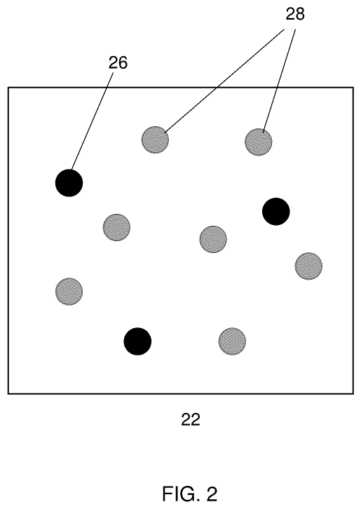

FIG. 2 illustrates a schematic view of the ceramic composite dielectric material 22 according to one aspect of the disclosure. The ceramic composite dielectric material 22 comprises polyimide binder 26 and ceramic filler 28. The diameter of a particle of ceramic filler 28 may be less than 10 microns, and preferably between 0.1 and 2.0 microns. The ceramic filler 28 may be a carbon oxide, selected from a group that includes Aluminum Oxide (Al₂O₃), Aluminium Oxyhydroxide (AlOOH), Aluminium Hydroxide (Al(OH)₃), Lead Zirconate Titanate (Pb(Zr,Ti)O₃), Titanium Dioxide (TiO₂), Zirconium Dioxide (ZrO₂), Yttrium Oxide (Y₂O₃), Yttria-Stabilized Zirconia (YSZ), Dysprosium Oxide (Dy₂O₃), Gadolinium Oxide (Gd₂O₃), Cerium Dioxide (CeO₂), Gadolinia-Doped Ceria (GDC), Magnesium Oxide (MgO), Barium Titanate (BaTiO₃), Nickel Manganese Oxide (NiMn₂O₄), Potassium Sodium Niobate (KNaNbO₃), Bismuth Potassium Titanate (BiKTiO₃), Bismuth Ferrite (BiFeO₃), Bismuth Zinc Niobate (Bi_{1.5}Zn₁Nb_{1.5}O₇), Tungsten Oxide (WO), Tin Dioxide (SnO₂), Lanthanum Strontium Manganese Oxide (LSMO), Lanthanum Strontium Ferrite Cobaltite (LSFC), Silicon Dioxide (SiO₂), Zinc Oxide (ZnO), Hafnium Dioxide (HfO₂), Calcium Oxide (CaO), Cobalt Ferrite (CoFe₂O₄), Nickel Ferrite (NiFe₂O₄), Barium Ferrite (BaFe₂O₄), Nickel Zinc Ferrite (NiZnFe₂O₄), Zinc Ferrite (ZnFe₂O₄), or Manganese Cobalt Oxide (MnₓCo₃₋ₓO₄).

In some configurations, the ceramic filler 28 may be a nitride, such as Aluminum Nitride (AlN), Silicon Nitride (Si₃N₄), or Titanium Nitride (TiN). In other configurations, the ceramic filler 28 may be a carbide, such as Silicon Carbide (SiC), Titanium Carbide (TiC), or Tungsten Carbide (WC). In other configurations, the ceramic filler 28 may be a boride, such as Magnesium Boride (MgB₂) or Titanium Boride (TiB₂). The polyimide binder 26 to ceramic filler 28 ratio is at least 1:99. However, preferably the ratio of polyimide binder 26 to ceramic filler 28 is between 10:90 and 30:70. The polyimide binder 26 may be selected from a group that includes Polyimide (PI), Polyamide-imide (PAI), Polyvinylidene Fluoride (PVDF), Polyurethane (PU), Polyurea, Polycarbonate (PC), Polyethylene Terephthalate (PET), Polymethyl Methacrylate (PMMA), Polybutylene Terephthalate (PBT), Polyvinyl Alcohol (PVA), or Polyvinyl Butyral (PVB).

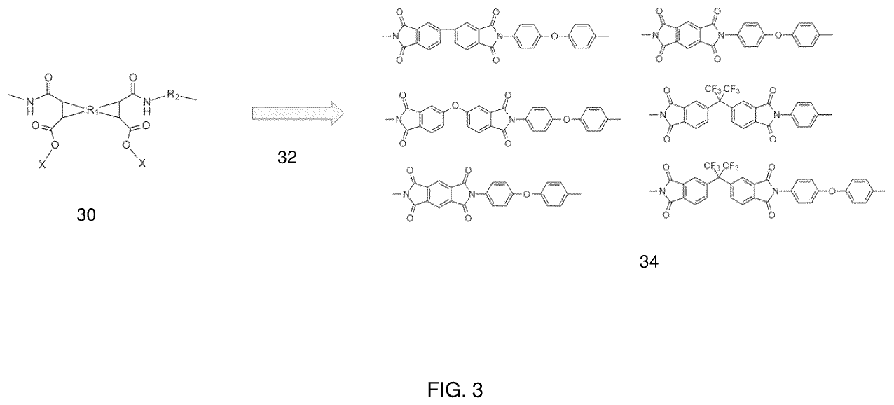

FIG. 3 illustrates a polyamic acid 30 undergoing a process 32 to form potential polyimides 34 according to one aspect of the disclosure. The polyamic acid 30 may contain various cationic substitutions at position X, including hydrogen (H), lithium (Li), sodium (Na), potassium (K), ammonium (NH₄), cesium (Cs), among others. The presence of cations and carboxylate forms may influence the curing speed and temperature of the resulting polyimide 34. Additionally, the molecular structure of polyamic acid 30 features variable groups at positions R1 and R2, which may consist of substituted aromatics, aliphatic cycles, alkyl groups, and other possible substituents. In process 32 the polyamic acid 30 is mixed with ceramic filler in a slurry then thermally cured to polyimides 34, this can be done in the production of a ceramic composite dielectric material 22 as shown in FIGS. 1 and 2. The yellow to brownish color of polyimides 34 benefits ease of defect detection in the vison system.

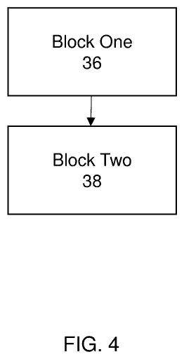

FIG. 4 illustrates a flowchart of a method according to one aspect of the disclosure. In Block One 36 during the manufacture of a plurality of positive electrode assemblies, each assembly includes a metal foil current collector with a positive active material coated on a portion of the metal foil current collector. A ceramic composite dielectric material is coated adjacent to and extending away from the active material towards the uncoated end of the metal foil current collector. The composite dielectric material comprises a polyimide binder and ceramic filler. As part of the quality control process, a chromatic analysis is conducted on these positive electrode assemblies. If the analysis indicates that a region of the ceramic composite dielectric material in any one of the assemblies lacks the expected yellow or brown color, that particular assembly is identified and segregated from the rest. In some configurations the method may include an optional further step in Block Two 38 further comprising the plurality of positive electrode assemblies having the expected yellow or brown color sent for packing with a plurality of separators and negative electrodes to form complete cells of a battery.

The algorithms, methods, or processes disclosed or suggested herein may be deliverable to or implemented by a computer, controller, or processing device, which can include any dedicated electronic control unit or programmable electronic control unit. Similarly, the algorithms, methods, or processes may be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes may also be implemented in software executable objects. Alternatively, the algorithms, methods, or processes may be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A battery comprising:
a negative electrode assembly;
a positive electrode assembly including a metal foil current collector, a positive active material coated on a portion of the metal foil current collector, and a ceramic composite dielectric material of polyimide binder and ceramic filler coated on another portion of the metal foil current collector adjacent to and extending away from the positive active material toward an uncoated end of the metal foil current collector; and
a separator disposed between the negative and positive electrode assemblies such that the ceramic composite dielectric material extends at least to an end of the separator and movement of the uncoated end toward the separator results in contact between the ceramic composite dielectric material and the end.

2. The battery of claim 1 wherein the ceramic filler is a carbon oxide.

3. The battery of claim 2 wherein the carbon oxide is selected from a group comprising Al₂O₃, AlOOH, Al(OH)₃, Pb(Zr,Ti)O₃, TiO₂, ZrO₂, Y₂O₃, YSZ, Dy₂O₃, Gd₂O₃, CeO₂, GDC, MgO, BaTiO₃, NiMn₂O₄, KNaNbO₃, BiKTiO₃, BiFeO₃, Bi_{1.5}Zn₁Nb_{1.5}O₇, WO, SnO₂, LSMO, LSFC, SiO₂, ZnO, HfO₂, CaO, CoFe2O4, NiFe₂O₄, BaFe₂O₄, NiZnFe₂O₄, ZnFe₂O₄, or MnxCo₃₋ₓO₄.

4. The battery of claim 1 wherein the ceramic filler is a nitride.

5. The battery of claim 4 wherein the nitride is selected from a group comprising aluminum nitride, silicon nitride, or titanium nitride.

6. The battery of claim 1 wherein the ceramic filler is a carbide.

7. The battery of claim 6 wherein the carbide is selected from a group comprising silicon carbide, titanium carbide, or tungsten carbide.

8. The battery of claim 1 wherein the ceramic filler is a boride.

9. The battery of claim 8 wherein the boride is selected from a group comprising magnesium boride or titanium boride.

10. The battery of claim 1 wherein a ratio of polyimide binder to ceramic filler is between 10:90 and 30:70.

11. The battery of claim 1 wherein the polyimide binder is selected from a group comprising PI, PAI, PVDF, PU, polyurea, PC, PET, PMMA, PBT, PVA, or PVB.

12. The battery of claim 1 wherein a diameter of a particle of ceramic filler is less than 10 microns.

13. The battery of claim 12 wherein a diameter of a particle of ceramic filler is between 0.1 and 2.0 microns.

14. The battery of claim 1 wherein a thickness of the ceramic composite dielectric material is between 1 and 100 microns from a surface of the metal foil current collector to a surface of the ceramic composite dielectric material.

15. The battery of claim 14 wherein a thickness of the ceramic composite dielectric material is between 1 and 50 microns from a surface of the current collector to a surface of the ceramic composite dielectric material.

16. The battery of claim 1 wherein the ceramic composite dielectric material extends past an end of the separator.

17. A method comprising:
during manufacture of a plurality of positive electrode assemblies each including a metal foil current collector, a positive active material coated on a portion of the metal foil current collector, and a ceramic composite dielectric material of polyimide binder and ceramic filler coated on another portion of the metal foil current collector adjacent to and extending away from the positive active material toward an uncoated end of the metal foil current collector, and responsive to an automatic chromatic analysis of one of the positive electrode assemblies indicating that a region of the corresponding ceramic composite dielectric material lacks a yellow or brown color, segregating the one from the plurality.

18. The method of claim 17 wherein the ceramic filler is selected from a group comprising oxides, nitrides, carbides, or borides.

19. The method of claim 17, further comprising packing the plurality of positive electrode assemblies with a plurality of separators and negative electrodes to form complete cells of a battery.

20. A method comprising:
applying a ceramic composite dielectric slurry of polyamic acid and ceramic filler onto a metal foil current collector from a portion of the metal current collector foil coated with active material to an uncoated end of the metal foil current collector; and
curing to form a positive electrode assembly including a ceramic composite dielectric material of polyimide binder and ceramic filler.
